(19) United States
(12) Patent Application Publication
(10) Pub. No.: US 2013/0054227 A1
(43) Pub. Date: Feb. 28, 2013

(54) Phonetic Symbol System

(71) Applicants: George Mizhen Wang, Fremont, CA (US); Lili Ni Wang, Fremont, CA (US)

(72) Inventors: George Mizhen Wang, Fremont, CA (US); Lili Ni Wang, Fremont, CA (US)

(21) Appl. No.: 13/219,680

(22) Filed: Aug. 28, 2011

(51) Int. Cl. G06F 17/27

(52) U.S. Cl. 704/9; 704/E11.001

(57) ABSTRACT

A phonetic symbol system formed by phonetic symbols using letters of English Alphabet is described. The cases or the styles of the letters do not affect the sounds of the phonetic symbols. The phonetic symbols are systematically and logically defined. The phonetic symbol system can be used where language is involved. The phonetic symbol system provides convenient ways to represent languages. In some embodiments, the phonetic symbol system provides ways to represent English language.

### BACKGROUND

This application relates to language phonetic symbols and phonetic symbol systems.

The following is a tabulation of some prior art that presently appears relevant.

### U.S. Patents

| Pat. No. | Issue Date | Patentee |
|---|---|---|
| U.S. Pat. No. 6,468,083 B1 | 2002-10-22 | Mathias |
| U.S. Pat. No. 7,004,758 B2 | 2006-02-28 | Su |

Many languages are not phonetic. In these languages, pronouncing written words can be difficult. Generally, people use phonetic symbol systems to represent the sounds.

Two popular phonetic symbol systems are International Phonetic Alphabet (IPA) and Webster Pronunciation Symbols. These phonetic symbol systems use diacritic marks or symbols that are different from letters of English alphabet. These marks and symbols are not only hard to learn but also hard to type using computer keyboards because most computer keyboards have been designed with English alphabet on the keys for conveniently inputting English alphabet.

Some phonetic symbol systems are using English alphabet. Simplified Respelling is one of such phonetic symbol systems used in some dictionaries.

However, the Simplified Respelling systems used in these dictionaries use uppercase letters to represent sounds that are different from the sounds represented by the lower case letters, or they use italic style letters to represent sounds that are different from the sounds represented by the regular style letters. For example, they use th to represent the sound of “th” in English word thin and use TH or th to represent the sound of “th” in English word this.

NuEnglish may be considered as a Simplified Respelling. The problem with NuEnglish is not only it uses a macron (a bar over a vowel) to represent a long vowel but also it uses letter u to represent both the sound of “a” in English word zebra and the sound of “u” in English word duck, while these two sounds are actually not the same.

The phonetic symbol system of the present invention uses letters of English alphabet to form phonetic symbols. It overcomes the problems mentioned above. The phonetic symbols are systematically and logically defined. The phonetic symbol system provides convenient ways to represent languages. It is easy for people to learn and use.

### DETAILED DESCRIPTION OF THE PREFERED EMBODIENTS

### A. First Preferred Embodiment

The phonetic symbol system is formed by phonetic symbols each of which is defined by one or more than one letter of English alphabet. The case or the style of the letter does not affect the sounds of the phonetic symbols. An English vowel or consonant is distinctively represented by one of the phonetic symbols. The phonetic symbols can be used to represent vowels, consonants, syllables, words, sentences, etc.

The phonetic symbols representing consonants are consonant phonetic symbols and the phonetic symbols representing vowels are vowel phonetic symbols. One English consonant corresponds to one of the consonant phonetic symbols. One English vowel corresponds to one of the vowel phonetic symbols.

### 1. Vowel Phonetic Symbols

A vowel, except the vowel equivalent to the sound of “ir” in English word bird, is represented by a, e, i, o, u, or a series of letters each of which is a, e, i, o, or u. A vowel phonetic symbol with single letter is denoted by a, e, i, o, or u. Common vowel phonetic symbols are defined as follows.

Symbol a represents the sound equivalent to the sound of “a” in English word about. Symbol e represents the sound equivalent to the sound of “e” in English word bed. Symbol i represents the sound equivalent to the sound of “i” in English word dig. Symbol o represents the sound equivalent to the sound of “o” in English word hot. Symbol u represents the sound equivalent to the sound of “u” in English word up. Symbol aa represents the sound equivalent to the sound of “a” in English word father. Symbol ae represents the sound equivalent to the sound of “ai” in English word aid. Symbol ai represents the sound equivalent to the sound of “a” in English word apple. Symbol ao represents the sound equivalent to the sound of “a” in English word all. Symbol ee represents the sound equivalent to the sound of “ee” in English word see. Symbol ie represents the sound equivalent to the sound of “i” in English word idea. Symbol oe represents the sound equivalent to the sound of “o” in English word go. Symbol oi represents the sound equivalent to the sound of “oi” in English word oil. Symbol oo represents the sound equivalent to the sound of “oo” in English word good. Symbol ou represents the sound equivalent to the sound of “ou” in English word out. Symbol ue represents the sound equivalent to the sound of “oo” in English word food. Symbol ur represents the sound equivalent to the sound of “ir” in English word bird.

Examples of words using common vowel phonetic symbols are shown in Table 1.

TABLE 1
Examples of Words Using Common Vowel Phonetic Symbols

| Vowel Phonetic | | Corresponding |
|---|---|---|
| Symbols | Phonetic Word Examples | English Words |
| a | about, zeebra | about, zebra |
| e | bed, hed | bed, head |
| i | dig, it | dig, it |
| o | hot, od | hot, odd |
| u | duk, up | duck, up |
| aa | kaam, paam | calm, palm |
| ae | aed, dae | aid, day |
| ai | aipl, hait | apple, hat |
| ao | aol, laost | all, lost |
| ee | dileet, eec | delete, each |
| ie | dinie, hied | deny, hide |
| oe | goe, roed | go, road |
| oi | boil, toi | boil, toy |
| oo | good, poot | good, put |
| ou | out, loud | out, loud |
| ue | fued, myuezik | food, music |
| ur | burd, urj | bird, urge |

Some of the vowels listed above are compound vowels. Vowel phonetic symbols for representing compound vowels not listed above can generally be derived from the above vowel phonetic symbols. The following is a common way for deriving these vowel phonetic symbols.

A compound vowel can generally be represented by a compound of vowel phonetic symbols. When a compound vowel is represented by a compound of vowel phonetic symbols, sound of the compound vowel is pronounced by continuously pronouncing each of the sounds of the vowel phonetic symbols one after another. The compound of the vowel phonetic symbols representing the compound vowel is the vowel phonetic symbol for the compound vowel.

For example, symbol aea is a compound of symbol ae and symbol a, symbol ea is a compound of symbol e and symbol a, symbol iea is a compound of symbol ie and symbol a, symbol is is a compound of symbol i and symbol a, symbol oea is a compound of symbol oe and symbol a, symbol oia is a compound of symbol of and symbol a, symbol ooa is a compound of symbol oo and symbol a, symbol oua is a compound of symbol ou and symbol a, and symbol uea is a compound of symbol ue and symbol a.

### 2. Consonant Phonetic Symbols

Consonant phonetic symbols are defined as follows.

Symbol b represents the sound equivalent to the sound of “b” in English word boy. Symbol c represents the sound equivalent to the sound of “ch” in English word check. Symbol d represents the sound equivalent to the sound of “d” in English word dig. Symbol dh represents the sound equivalent to the sound of “th” in English word this. Symbol f represents the sound equivalent to the sound of “f” in English word free. Symbol g represents the sound equivalent to the sound of “g” in English word good. Symbol h represents the sound equivalent to the sound of “h” in English word hot. Symbol j represents the sound equivalent to the sound of “j” in English word just. Symbol k represents the sound equivalent to the sound of “ck” in English word check. Symbol l represents the sound equivalent to the sound of “l” in English word list. Symbol m represents the sound equivalent to the sound of “m” in English word more. Symbol n represents the sound equivalent to the sound of “n” in English word snow. Symbol ng represents the sound equivalent to the sound of “ng” in English word long. Symbol p represents the sound equivalent to the sound of “p” in English word put. Symbol r represents the sound equivalent to the sound of “r” in English word run. Symbol s represents the sound equivalent to the sound of “s” in English word start. Symbol sh represents the sound equivalent to the sound of “sh” in English word shop. Symbol t represents the sound equivalent to the sound of “t” in English word top. Symbol th represents the sound equivalent to the sound of “th” in English word thin. Symbol v represents the sound equivalent to the sound of “v” in English word vote. Symbol w represents the sound equivalent to the sound of “w” in English word wear. Symbol x represents the sound equivalent to the sound of “ge” in English word beige. Symbol y represents the sound equivalent to the sound of “y” in English word young. Symbol z represents the sound equivalent to the sound of “z” in English word zoo.

Examples of words using consonant phonetic symbols are shown in Table 2.

TABLE 2
Examples of Words Using Consonant Phonetic Symbols

| Consonant Phonetic | | Corresponding |
|---|---|---|
| Symbols | Phonetic Word Examples | English Words |
| b | boi, baebi | boy, baby |
| c | cek, woc | check, watch |
| d | dig, red | dig, red |
| dh | breedh, dhis | breathe, this |
| f | free, tuf | free, tough |
| g | good, graet | good, great |
| h | ahed, hot | ahead, hot |
| j | aej, just | age, just |
| k | cek, kyuet | check, cute |
| l | lief, list | life, list |
| m | maek, tiem | make, time |
| n | injoiabl, snoe | enjoyable, snow |
| ng | long, sing | long, sing |
| p | keep, poot | keep, put |
| r | run, veri | run, very |
| s | faesiz, promis | faces, promise |
| sh | poosh, shop | push, shop |
| t | its, tops | its, tops |
| th | maith, thrue | math, through |
| v | stoev, voet | stove, vote |
| w | awae, wontid | away, wanted |
| x | baex, telivixan | beige, television |
| y | unyan, yes | onion, yes |
| z | buz, eezi | buzz, easy |

### 3. Sentence

The phonetic symbols can be used to represent sentences. For example, English sentence “This is great.” can be represented as “Dhis iz graet.”

### B. Second Preferred Embodiment

This embodiment is based on the first preferred embodiment and can also be applied to some other embodiments. In this embodiment, vowel phonetic symbols a, e, i, o, u, aa, ae, ai, ao, ee, ie, oe, oi, oo, ou, ue, ur, and consonant phonetic symbols are defined the same way as the ones in the first preferred embodiment. In addition, this embodiment provides one of the ways to specify spellings of the combinations of vowels and the r-sound.

We call the sound equivalent to the sound “r” in English word teacher r-sound. The r-sound is pronounced in some English dialects such as American English but is not pronounced in some English dialects such as British English.

Generally, combinations of vowels with the r-sound can be represented by adding letter r to the ends of the vowel phonetic symbols. The following are examples.

Symbol aar represents the sound equivalent to the sound of “ar in English word arm. Symbol aear represents the sound equivalent to the sound of “ayer” in English word layer. Symbol aor represents the sound equivalent to the sound of “or” in English word for. Symbol ar represents the sound equivalent to the sound of “er” in English word teacher. Symbol ear represents the sound equivalent to the sound of “are” in English word dare. Symbol iear represents the sound equivalent to the sound of “ire” in English word fire. Symbol iar represents the sound equivalent to the sound of “ear” in English word dear. Symbol oear represents the sound equivalent to the sound of “ower” in English word lower. Symbol oiar represents the sound equivalent to the sound of “oyer” in English word employer. Symbol ooar represents the sound equivalent to the sound of “our” in English word tour. Symbol or represents the sound equivalent to the sound of “or” in English word coral. Symbol ouar represents the sound equivalent to the sound of “ower” in English word power. Symbol uear represents the sound equivalent to the sound of “ewer” in English word brewer.

In the first preferred embodiment, there are examples showing some compound vowel phonetic symbols. If the r-sound is not pronounced, symbol aea and symbol aear are pronounced the same, symbol ea and symbol ear are pronounced the same, symbol iea and symbol iear are pronounced the same, symbol is and symbol iar are pronounced the same, symbol oea and symbol oear are pronounced the same, symbol oia and symbol oiar are pronounced the same, symbol ooa and symbol ooar are pronounced the same, symbol oua and symbol ouar are pronounced the same, and symbol uea and symbol uear are pronounced the same.

### C. Third Preferred Embodiment

This embodiment is based on the first preferred embodiment and can also be applied to some other embodiments. In this embodiment, vowel phonetic symbols a, e, i, o, u, aa, ae, ai, ao, ee, ie, oe, oi, oo, ou, ue, ur, and consonant phonetic symbols are defined the same way as the ones in the first preferred embodiment. In addition, this embodiment provides one of the ways to simplify some spellings of the combinations of vowels and the r-sound.

Generally, combinations of vowels with the r-sound can be represented by adding letter r to the ends of the vowel phonetic symbols. However, some can be simplified. For example, aer, er, ier, ir, oer, oir, oor, our and uer are simplified forms of aear, ear, iear, iar, oear, oiar, ooar, ouar and uear respectively. The following explains these examples.

Symbol aer represents the sound equivalent to the sound of “ayer” in English word layer. Symbol er represents the sound equivalent to the sound of “are” in English word dare. Symbol ier represents the sound equivalent to the sound of “ire” in English word fire. Symbol it represents the sound equivalent to the sound of “ear” in English word dear. Symbol oer represents the sound equivalent to the sound of “ower” in English word lower. Symbol oir represents the sound equivalent to the sound of “oyer” in English word employer. Symbol oor represents the sound equivalent to the sound of “our” in English word tour. Symbol our represents the sound equivalent to the sound of “ower” in English word power. Symbol uer represents the sound equivalent to the sound of “ewer” in English word brewer.

### D. Fourth Preferred Embodiment

This embodiment is based on the first preferred embodiment and can also be applied to some other embodiments. In this embodiment, vowel phonetic symbols a, e, i, o, u, aa, ae, ai, ao, ee, ie, oe, oi, oo, ou, ue, ur, and consonant phonetic symbols are defined the same way as the ones in the first preferred embodiment. In addition, this embodiment provides rules for the use of symbol r.

Within a word, if an r is immediately before a vowel, the r is in the same syllable which the vowel is in. Otherwise, an r is in the same syllable which the vowel which the r is immediately after is in.

In the following phonetic word examples, the r is in the same syllable which the vowel which the r is before is in:
run
riet
rai
veri

In the following phonetic word examples, the r is in the same syllable which the vowel which the r is immediately after is in:
teecar
aiftarnuen
faorward

In the following phonetic word example, the first r is in the same syllable which the vowel which the r is immediately after is in and the second r is in the same syllable which the vowel which the r is before is in:
waorran

### E. Fifth Preferred Embodiment

This embodiment is based on the first preferred embodiment and can also be applied to some other embodiments. In this embodiment, vowel phonetic symbols a, e, i, o, u, aa, ae, ai, ao, ee, ie, oe, oi, oo, ou, ue, ur, and consonant phonetic symbols are defined the same way as the ones in the first preferred embodiment. In addition, this embodiment uses a silent symbol.

A silent symbol is a special phonetic symbol. We use symbol q to represent a silent symbol. Symbol q is not pronounced. It can be used as a separator. When being used as a separator, symbol q separates two letters in a word if the two letters connected to each other are not in one consonant, vowel, or syllable but are easy to be confused as in one consonant, vowel, or syllable.

### F. Sixth Preferred Embodiment

This embodiment is an alternative embodiment to the first preferred embodiment and can also be applied to some other embodiments. In this embodiment, vowel phonetic symbols a, e, i, o, u, aa, ae, ai, ao, ee, ie, oe, oi, oo, ou, ue, ur, and consonant phonetic symbols are defined the same way as the ones in the first preferred embodiment except using symbol q instead of ng to represent the sound equivalent to the sound of “ng” in English word long.

What is claimed is:

1. A phonetic symbol system comprising:
a plurality of phonetic symbols, wherein each of said phonetic symbols is defined by one or more than one letter of English alphabet, the case or the style of said letter does not affect the sounds of said phonetic symbols, there are vowel phonetic symbols and consonant phonetic symbols of said phonetic symbols, each vowel is distinctively represented by one of said vowel phonetic symbols, and each consonant is distinctively represented by one of said consonant phonetic symbols.

2. A phonetic symbol system comprising:
a plurality of phonetic symbols, wherein each of said phonetic symbols is defined by one or more than one letter of English alphabet, the case or the style of said letter does not affect the sounds of said phonetic symbols, there are vowel phonetic symbols and consonant phonetic symbols of said phonetic symbols, each English vowel is distinctively represented by one of said vowel phonetic symbols, and each English consonant is distinctively represented by one of said consonant phonetic symbols.

3. The phonetic symbol system of claim 2 wherein each of English vowels except the vowel equivalent to the sound of “ir” of English word bird is represented by a, e, i, o, u, or a series of letters each of which is a, e, i, o, or u.

4. The phonetic symbol system of claim 2 wherein symbol a represents the sound equivalent to the sound of “a” in English word about.

5. The phonetic symbol system of claim 2 wherein symbol u represents the sound equivalent to the sound of “u” in English word up.

6. The phonetic symbol system of claim 2 wherein symbol ai represents the sound equivalent to the sound of “a” in English word apple.

7. The phonetic symbol system of claim 2 wherein symbol ao represents the sound equivalent to the sound of “a” in English word all.

8. The phonetic symbol system of claim 2 wherein symbol ar represents the sound equivalent to the sound of “er” in English word teacher.

9. The phonetic symbol system of claim 2 wherein symbol ur represents the sound equivalent to the sound of “ir” in English word bird.

10. The phonetic symbol system of claim 2 wherein symbol x represents the sound equivalent to the sound of “ge” in English word beige.

11. The phonetic symbol system of claim 2 wherein symbol q represents the sound equivalent to the sound of “ng” in English word long.

12. The phonetic symbol system of claim 2 wherein symbol q represents a silent symbol, and said symbol q can be used as a separator to separates two letters if the two letters connected to each other are not in one consonant, vowel, or syllable but are easy to be confused as in one consonant, vowel, or syllable.

13. The phonetic symbol system of claim 2 wherein the following rule is used to determine which syllable an r is in:
within a word, if an r is immediately before a vowel, the r is in the same syllable which said vowel is in, and otherwise an r is in the same syllable which the vowel which the r is immediately after is in.

14. The phonetic symbol system of claim 2 wherein
symbol a represents the sound equivalent to the sound of “a” in English word about,
symbol e represents the sound equivalent to the sound of “e” in English word bed,
symbol i represents the sound equivalent to the sound of “i” in English word dig,
symbol o represents the sound equivalent to the sound of “o” in English word hot, and
symbol u represents the sound equivalent to the sound of “u” in English word up.

15. The phonetic symbol system of claim 2 wherein
symbol aa represents the sound equivalent to the sound of “a” in English word father,
symbol ae represents the sound equivalent to the sound of “ai” in English word aid,
symbol ai represents the sound equivalent to the sound of “a” in English word apple,
symbol ao represents the sound equivalent to the sound of “a” in English word all,
symbol ee represents the sound equivalent to the sound of “ee” in English word see,
symbol ie represents the sound equivalent to the sound of “i” in English word idea,
symbol oe represents the sound equivalent to the sound of “o” in English word go,
symbol oi represents the sound equivalent to the sound of “oi” in English word oil,
symbol oo represents the sound equivalent to the sound of “oo” in English word good,
symbol ou represents the sound equivalent to the sound of “ou” in English word out,
symbol ue represents the sound equivalent to the sound of “oo” in English word food, and
symbol ur represents the sound equivalent to the sound of “ir” in English word bird.

16. The phonetic symbol system of claim 2 wherein
symbol aar represents the sound equivalent to the sound of “ar in English word arm,
symbol aer represents the sound equivalent to the sound of “ayer” in English word layer,
symbol aor represents the sound equivalent to the sound of “or” in English word for,
symbol ar represents the sound equivalent to the sound of “er” in English word teacher,
symbol er represents the sound equivalent to the sound of “are” in English word dare,
symbol ier represents the sound equivalent to the sound of “ire” in English word fire,
symbol ir represents the sound equivalent to the sound of “ear” in English word dear,
symbol oer represents the sound equivalent to the sound of “ower” in English word lower,
symbol oir represents the sound equivalent to the sound of “oyer” in English word employer,
symbol oor represents the sound equivalent to the sound of “our” in English word tour,
symbol or represents the sound equivalent to the sound of “or” in English word coral,
symbol our represents the sound equivalent to the sound of “ower” in English word power, and
symbol uer represents the sound equivalent to the sound of “ewer” in English word brewer.

17. The phonetic symbol system of claim 2 wherein
symbol b represents the sound equivalent to the sound of “b” in English word boy,
symbol c represents the sound equivalent to the sound of “ch” in English word check,
symbol d represents the sound equivalent to the sound of “d” in English word dig,
symbol dh represents the sound equivalent to the sound of “th” in English word this,
symbol f represents the sound equivalent to the sound of “f” in English word free,
symbol g represents the sound equivalent to the sound of “g” in English word good,
symbol h represents the sound equivalent to the sound of “h” in English word hot,
symbol j represents the sound equivalent to the sound of “j” in English word just,
symbol k represents the sound equivalent to the sound of “ck” in English word check,
symbol l represents the sound equivalent to the sound of “l ” in English word list,
symbol m represents the sound equivalent to the sound of “m” in English word more,
symbol n represents the sound equivalent to the sound of “n” in English word snow,
symbol ng represents the sound equivalent to the sound of “ng” in English word long,
symbol p represents the sound equivalent to the sound of “p” in English word put,
symbol r represents the sound equivalent to the sound of “r” in English word run,
symbol s represents the sound equivalent to the sound of “s” in English word start,
symbol sh represents the sound equivalent to the sound of “sh” in English word shop,
symbol t represents the sound equivalent to the sound of “t” in English word top,
symbol th represents the sound equivalent to the sound of “th” in English word math,
symbol v represents the sound equivalent to the sound of “v” in English word vote,
symbol w represents the sound equivalent to the sound of “w” in English word wear,
symbol x represents the sound equivalent to the sound of “ge” in English word beige,
symbol y represents the sound equivalent to the sound of “y” in English word young, and
symbol z represents the sound equivalent to the sound of “z” in English word zoo.

18. The phonetic symbol system of claim 2 wherein
symbol a represents the sound equivalent to the sound of “a” in English word about,
symbol e represents the sound equivalent to the sound of “e” in English word bed,
symbol i represents the sound equivalent to the sound of “i” in English word dig,
symbol o represents the sound equivalent to the sound of “o” in English word hot,
symbol u represents the sound equivalent to the sound of “u” in English word up,
symbol aa represents the sound equivalent to the sound of “a” in English word father,
symbol ae represents the sound equivalent to the sound of “ai” in English word aid,
symbol ai represents the sound equivalent to the sound of “a” in English word apple,
symbol ao represents the sound equivalent to the sound of “a” in English word all,
symbol ee represents the sound equivalent to the sound of “ee” in English word see,
symbol ie represents the sound equivalent to the sound of “i” in English word idea,
symbol oe represents the sound equivalent to the sound of “o” in English word go,
symbol oi represents the sound equivalent to the sound of “oi” in English word oil,
symbol oo represents the sound equivalent to the sound of “oo” in English word good,
symbol ou represents the sound equivalent to the sound of “ou” in English word out,
symbol ue represents the sound equivalent to the sound of “oo” in English word food,
symbol ur represents the sound equivalent to the sound of “ir” in English word bird,
symbol b represents the sound equivalent to the sound of “b” in English word boy,
symbol c represents the sound equivalent to the sound of “ch” in English word check,
symbol d represents the sound equivalent to the sound of “d” in English word dig,
symbol dh represents the sound equivalent to the sound of “th” in English word this,
symbol f represents the sound equivalent to the sound of “f” in English word free,
symbol g represents the sound equivalent to the sound of “g” in English word good,
symbol h represents the sound equivalent to the sound of “h” in English word hot,
symbol j represents the sound equivalent to the sound of “j” in English word just,
symbol k represents the sound equivalent to the sound of “ck” in English word check,
symbol l represents the sound equivalent to the sound of “l” in English word list,
symbol m represents the sound equivalent to the sound of “m” in English word more,
symbol n represents the sound equivalent to the sound of “n” in English word snow,
symbol ng represents the sound equivalent to the sound of “ng” in English word long,
symbol p represents the sound equivalent to the sound of “p” in English word put,
symbol r represents the sound equivalent to the sound of “r” in English word run,
symbol s represents the sound equivalent to the sound of “s” in English word start,
symbol sh represents the sound equivalent to the sound of “sh” in English word shop,
symbol t represents the sound equivalent to the sound of “t” in English word top,
symbol th represents the sound equivalent to the sound of “th” in English word math,
symbol v represents the sound equivalent to the sound of “v” in English word vote,
symbol w represents the sound equivalent to the sound of “w” in English word wear,
symbol x represents the sound equivalent to the sound of “ge” in English word beige,
symbol y represents the sound equivalent to the sound of “y” in English word young, and
symbol z represents the sound equivalent to the sound of “z” in English word zoo.

19. A phonetic symbol system comprising:
a plurality of phonetic symbols, wherein each of said phonetic symbols is defined by one or more than one letter of twenty five letters from English alphabet, the case or the style of said letter does not affect the sounds of said phonetic symbols, there are vowel phonetic symbols and consonant phonetic symbols of said phonetic symbols, each English vowel is distinctively represented by one of said vowel phonetic symbols, and each English consonant is distinctively represented by one of said consonant phonetic symbols.

20. The phonetic symbol system of claim 19 wherein
symbol a represents the sound equivalent to the sound of “a” in English word about,
symbol e represents the sound equivalent to the sound of “e” in English word bed,
symbol i represents the sound equivalent to the sound of “i” in English word dig,
symbol o represents the sound equivalent to the sound of “o” in English word hot,
symbol u represents the sound equivalent to the sound of “u” in English word up,
symbol aa represents the sound equivalent to the sound of “a” in English word father,
symbol ae represents the sound equivalent to the sound of “ai” in English word aid,
symbol ai represents the sound equivalent to the sound of “a” in English word apple,
symbol ao represents the sound equivalent to the sound of “a” in English word all,
symbol ee represents the sound equivalent to the sound of “ee” in English word see,
symbol ie represents the sound equivalent to the sound of “i” in English word idea,
symbol oe represents the sound equivalent to the sound of “o” in English word go,
symbol oi represents the sound equivalent to the sound of “oi” in English word oil,
symbol oo represents the sound equivalent to the sound of “oo” in English word good,
symbol ou represents the sound equivalent to the sound of “ou” in English word out,
symbol ue represents the sound equivalent to the sound of “oo” in English word food,
symbol ur represents the sound equivalent to the sound of “ir” in English word bird,
symbol aar represents the sound equivalent to the sound of “ar in English word arm,
symbol aer represents the sound equivalent to the sound of “ayer” in English word layer,
symbol aor represents the sound equivalent to the sound of “or” in English word for,
symbol ar represents the sound equivalent to the sound of “er” in English word teacher,
symbol er represents the sound equivalent to the sound of “are” in English word dare,
symbol ier represents the sound equivalent to the sound of “ire” in English word fire,
symbol it represents the sound equivalent to the sound of “ear” in English word dear,
symbol oer represents the sound equivalent to the sound of “ower” in English word lower,
symbol oir represents the sound equivalent to the sound of “oyer” in English word employer,
symbol oor represents the sound equivalent to the sound of “our” in English word tour,
symbol or represents the sound equivalent to the sound of “or” in English word coral,
symbol our represents the sound equivalent to the sound of “ower” in English word power,
symbol uer represents the sound equivalent to the sound of “ewer” in English word brewer,
symbol b represents the sound equivalent to the sound of “b” in English word boy,
symbol c represents the sound equivalent to the sound of “ch” in English word check,
symbol d represents the sound equivalent to the sound of “d” in English word dig,
symbol dh represents the sound equivalent to the sound of “th” in English word this,
symbol f represents the sound equivalent to the sound of “f” in English word free,
symbol g represents the sound equivalent to the sound of “g” in English word good,
symbol h represents the sound equivalent to the sound of “h” in English word hot,
symbol j represents the sound equivalent to the sound of “j” in English word just,
symbol k represents the sound equivalent to the sound of “ck” in English word check,
symbol l represents the sound equivalent to the sound of “l” in English word list,
symbol m represents the sound equivalent to the sound of “m” in English word more,
symbol n represents the sound equivalent to the sound of “n” in English word snow,
symbol ng represents the sound equivalent to the sound of “ng” in English word long,
symbol p represents the sound equivalent to the sound of “p” in English word put,
symbol r represents the sound equivalent to the sound of “r” in English word run,
symbol s represents the sound equivalent to the sound of “s” in English word start,
symbol sh represents the sound equivalent to the sound of “sh” in English word shop,
symbol t represents the sound equivalent to the sound of “t” in English word top,
symbol th represents the sound equivalent to the sound of “th” in English word math,
symbol v represents the sound equivalent to the sound of “v” in English word vote,
symbol w represents the sound equivalent to the sound of “w” in English word wear,
symbol x represents the sound equivalent to the sound of “ge” in English word beige,
symbol y represents the sound equivalent to the sound of “y” in English word young, and
symbol z represents the sound equivalent to the sound of “z” in English word zoo.
